(19) United States
(12) Patent Application Publication
(10) Pub. No.: US 2005/0199137 A1
(43) Pub. Date: Sep. 15, 2005

(54) Juicer arrangement

(75) Inventor: John Harding, Hants (GB)

Correspondence Address: FLEIT KAIN GIBBONS GUTMAN BONGINI & BIANCO, COURVOISIER CENTRE II, SUITE 404, 601 BRICKELL KEY DRIVE, MIAMI, FL, 33131, US

(73) Assignee: KENWOOD MARKS LIMITED, HAMPSHIRE (GB)

(21) Appl. No.: 11/064,441

(22) Filed: Feb. 22, 2005

Related U.S. Application Data
(63) Continuation of application No. PCT/GB03/03754, filed on Aug. 22, 2003.

(30) Foreign Application Priority Data
Aug. 31, 2002 (GB) 0220258.8

(51) Int. Cl. A23N 1/00

(52) U.S. Cl. 99/495

(57) ABSTRACT

A juicer arrangement is provided in the form of a motor-driven domestic appliance capable of extracting the juice from fruits, typically citrus fruits, and delivering the juice into a vessel positioned adjacent the main body of the appliance. In order to promote clean transfer of the juice into the vessel, and/or resist a tendency for the vessel to be moved away from the main body by reactive forces associated with start-up of the motor, the appliance is provided with a resiliently-loaded outlet duct for the juice which engages with an opening in a lid or cover of the vessel. Preferably, the outlet duct is a substantially straight and hollow tube supporting an outer collar that is spring-loaded for outward axial motion relative to the tube; the collar and/or the tube are retained together to prevent unwanted disengagement of the collar from the tube.

### RELATED APPLICATION

This application is a continuation of International Application Serial No. PCT/GB2003/003754, filed Aug. 22, 2003, the contents of which are here incorporated by reference in their entirety.

### BACKGROUND OF THE INVENTION

1. Field of the Invention

This invention relates to juicer arrangements, and more particularly to juicers intended for the domestic market and comprising motor-driven appliances capable of extracting the juice from fruits, typically citrus fruits, and delivering the juice into a vessel, such as a jug or carafe, that is positioned adjacent the main body of the appliance to receive the juice by way of an outlet duct.

2. Prior Art

Such appliances typically incorporate one or more filters, configured and located to retain solid, or semi-solid, materials such as pith, partly because the presence of undue amounts of such materials in the prepared juice is considered unpalatable by many users and partly because such materials tend to block outlet ducts, which thus require frequent cleaning.

The general arrangement is well established, can be economically manufactured and works quite well. Difficulties arise however in certain respects, such as ensuring that the juice flows cleanly (i.e. without undue splashing) into the vessel used to receive it, and resisting a tendency for the vessel to be propelled away from the motor-driven appliance, by reactive forces transmitted to the vessel by way of the casing of the motor-driven appliance, when the motor is started. These difficulties are particularly (though not exclusively) associated with centrifugal juicers.

### SUMMARY OF THE INVENTION

It is an object of this invention to provide a juicing arrangement in which at least one of the above-mentioned difficulties is reduced or overcome.

According to the invention there is provided a juicer arrangement comprising a motor-driven appliance capable of extracting juice from fruit and a vessel for receiving the juice; the appliance having a resiliently-loaded outlet duct for the juice and the vessel having a lid or cover means covering at least a portion of its opening, said lid or cover means being pre-formed with an opening dimensioned and configured to engage with said duct. By this means, the spring-loaded duct inserts at least part way into the opening and delivers the juice cleanly into the vessel.

Preferably, the outlet duct is so configured relative to the said opening that its resilient loading tends to resist movement of the vessel away from the body of the motor-driven appliance. By this means, the vessel can be constrained so as to remain in place despite the tendency for it to be propelled away from the main appliance by reactive forces generated in response to the driving motor being energized.

It is further preferred that the outlet duct comprises a substantially straight and hollow tube supporting an outer collar that is spring-loaded for outward axial motion relative to the tube; the collar and/or the tube being formed with retention means to prevent unwanted disengagement of the collar from the tube. By this means, the required resilience is provided in an efficient and economical manner.

Conveniently, the spring comprises a coiled spring disposed around a portion of said tube and disposed with its inwardly-facing end bearing against a fixed stop. This provides a reliable and robust construction.

Preferably, the tube is angled downwards from the appliance and thus provides a vertical component of resilient force, pressing downwardly on the vessel, when engaged with the opening in the vessel. The vertical component of force resists the aforementioned tendency for the vessel to be propelled away from the appliance.

It is also preferred that the opening in the lid or cover means of the vessel comprises an aperture dimensioned to snugly receive the collar and tube of the outlet duct. This ensures that the juice is delivered into the vessel without splashing.

Preferably too, the vessel and the appliance are designed to present complementary or contrasting appearances, and they may conveniently be shaped so as to interfit with one another. By this means, the design of the two components can be presented as an entity, whereby the use of non-matching vessels with the appliance is discouraged.

### BRIEF DESCRIPTION OF THE DRAWINGS OF THE INVENTION

In order that the invention may be clearly understood and readily carried into effect, one embodiment thereof will now be described, by way of example only, with reference to the accompanying drawings, of which:

FIG. 1 shows, in exploded perspective view, the essential components of a juicer arrangement in accordance with an embodiment of the invention, including the relevant parts of the main appliance, and also a vessel located to receive the juice; and

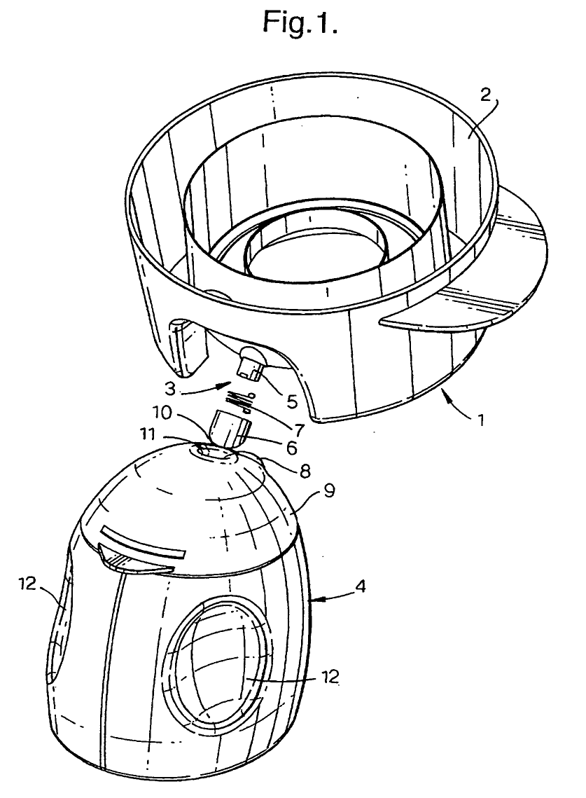

FIG. 2 shows a perspective view of the vessel from a different angle to that shown in FIG. 1.

### DETAILED DESCRIPTION OF PREFERRED EMBODIMENTS OF THE INVENTION

Referring now to the drawings, the arrangement comprises a juicer appliance, part of which is shown generally at 1 and which includes an annular liquid storage area 2 having an outlet duct 3 at a lower region thereof, whereby juice introduced into the area 2 as a result of the juicing action of the appliance can be dispensed into a receiving vessel comprising a jug or carafe 4.

The duct 3 comprises a fixed, inner tubular portion 5, and a mobile outer tubular portion 6 which can move telescopically to and fro in an axial direction relative to the fixed portion 5, under the influence of a spring 7 which is located and configured to resiliently force the outer portion 6 outwardly relative to the inner portion 5, so that its normal tendency is to adopt an extended position relative to the duct portion 5.

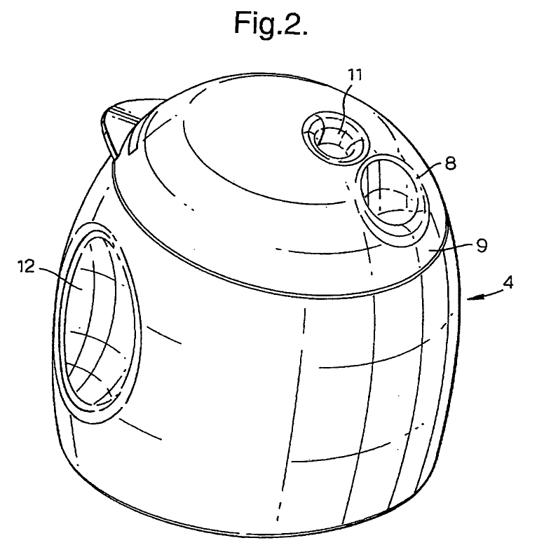

The lid 9 of the vessel 4 is formed with a spout 8 (best seen in FIG. 2) and it is further formed, in the vicinity of the spout 8, with an inlet opening 11 which, in this example, is separated from the spout aperture by a small distance. The inlet opening 11 is formed with smoothly tapering walls conforming to a frusto-conical configuration shaped and dimensioned to snugly accommodate the outer end region 10 of the mobile duct portion 6.

The arrangement is such that, when the vessel 4 is correctly located relative to the juicer so as to collect juice via the duct 3, the outer region 10 of the mobile duct portion 6 engages, under the extending influence of the spring 7, into the inlet opening 11 of the vessel 4 and thus fits snugly into that shaped region.

By that means, two important objectives are achieved. First, the clean delivery of juice from the storage chamber 2 of the juicer appliance 1 into the vessel 4 is assured, since the outer region 10 of the mobile duct portion 6 extends into the opening 11 which is shaped and designed to receive it. Second, the resilient engagement between the outer region 10 of the mobile tubular duct 6 and the vessel 4 ensures that the vessel 4 is not kicked away from the body of the juicer appliance 1 when the motor (not shown) of the appliance 1 is started. In this latter respect, it will be appreciated that, since the forces that tend to kick the vessel away from the appliance 1 tend to be primarily transverse (i.e. lateral of the vessel's base), it is important that the resilient restraining force applied to the vessel by way of the outer tubular portion 6 of the duct 3 has a sufficient lateral component to resist the kicking forces. In this embodiment of the invention, the application of the desired lateral component of force is achieved by having the axis of the duct 3 (and thus, of course, of the mobile duct portion 6) orientated at a suitable downward angle to the horizontal.

In this embodiment, the aforesaid downward angle is 49 degrees, but designs utilizing alternative angles of depression can be adopted if desired, particularly if, where a lesser angle is adopted, greater spring pressure is employed. Correspondingly, if the angle of depression is greater than that shown, the spring pressure can be reduced.

In the present embodiment, the shaping of the lid 9 in the vicinity of the inlet opening 11 is configured so as to permit the vessel 4, when being slid into place relative to the appliance 1, to engage smoothly with the outer region 10 of the mobile duct portion 6, and to compress the spring 7, whilst allowing the mobile duct portion 6 to ride smoothly backwards relative to the fixed tubular portion 5, and then be moved forwards again, under the influence of the spring, into the inlet opening 11, when the vessel 4 is properly located relative to the appliance 1. This arrangement is advantageous in providing tactile assurance for the user that the outer region 10 of the mobile duct portion 6 is properly engaged with the vessel.

Any convenient means can be utilized to ensure that the mobile portion 6 of the duct 3 is retained by, but capable of relative axial movement with respect to, the fixed portion 5. In this example, the rearwards end of the portion 6 bears a flange (not shown) extending radially inwards, and the forward end of the portion 5 bears a corresponding flange (not shown) which extends radially outwards, the arrangement being such that the flanges contain respective, cut-outs which, when aligned, permit the flange on the portion 6 to be slid past the flange on portion 5 for assembly. Thereafter, the portion 6 is rotated relative to the portion 5 to misalign the cut-outs such that inter-engagement of the two flanges retains the portion 6 relative to the portion 5.

The portion 6 is preferably retained resiliently in a rotational position relative to portion 5 such that the aforementioned cut-outs remain misaligned, by suitable location of the ends of the spring 7, though a linear channel and a tab, or other means can alternatively or additionally be provided for such retention if preferred.

The vessel 4 may be provided with any convenient means of lifting and carrying it, such as, conventional handles which may be molded integrally with the vessel or attached thereto by bands or in any other conventional manner. In this embodiment, however, the function of a handle is provided economically and in an aesthetically pleasing manner by forming a matched pair of indentations 12 in the upstanding wall of the vessel 4 and on the opposite side of the vessel to the spout 8. The vessel 4 and its contents are sufficiently light in weight that users can readily lift and manipulate the vessel single-handedly, using these indentations, by placing a thumb in one indentation and one or more fingers in the other, and applying slight squeezing pressure to the vessel. The indentations typically have the same surface finish as the remainder of the vessel 4. Where preferred, however, the surface of the vessel may be textured or otherwise roughened in the indented areas in order to increase the friction available for gripping the vessel. In alternative embodiments, cushioned or somewhat resilient pads are provided in the indentations 12; such pads being adherent in any convenient manner to the surface of the vessel.

1. A juicer arrangement comprising a motor-driven appliance capable of extracting juice from fruit and a vessel for receiving the juice; the appliance having a resiliently-loaded outlet duct for the juice and the vessel having a cover covering at least a portion of its opening, said cover being pre-formed with an opening dimensioned and configured to engage with said duct.

2. A juicer arrangement according to claim 1 wherein the outlet duct is configured relative to the said opening so that its resilient loading tends to resist movement of the vessel away from the body of the motor-driven appliance.

3. A juicer arrangement according to claim 1 wherein the outlet duct comprises a substantially straight and hollow tube supporting an outer collar that is spring-loaded for outward axial motion relative to the tube; one of the collar and the tube being formed with a retention member to prevent unwanted disengagement of the collar from the tube.

4. A juicer arrangement according to claim 3 wherein the spring-load comprises a coiled spring disposed around a portion of said tube and disposed with its inwardly-facing end bearing against a fixed stop.

5. A juicer arrangement according to claim 3 wherein the tube is angled downwards from the appliance and provides a vertical component of resilient force, pressing downwardly on the vessel, when engaged with the opening in the vessel.

6. A juicer arrangement according to claim 3, wherein the opening in the cover of the vessel comprises an aperture dimensioned to snugly receive the collar and tube of the outlet duct.

7. A juicer arrangement according to claim 1, wherein the vessel and the appliance present one of a complementary and contrasting appearance.

8. A juicer arrangement according to claim 7 wherein the vessel and the appliance are shaped to interfit with one another.
